(19) United States
(12) Patent Application Publication
(10) Pub. No.: US 2011/0169897 A1
(43) Pub. Date: Jul. 14, 2011

(54) LIQUID EJECTING HEAD AND LIQUID EJECTING APPARATUS

(75) Inventors: Naoto YOKOYAMA, Suwa-shi (JP); Eiju HIRAI, Minamiminowa-mura (JP)

(73) Assignee: SEIKO EPSON CORPORATION, Tokyo (JP)

(21) Appl. No.: 12/983,494

(22) Filed: Jan. 3, 2011

(30) Foreign Application Priority Data
Jan. 9, 2010 (JP) 2010-003448

(51) Int. Cl. B41J 2/045

(52) U.S. Cl. 347/70

(57) ABSTRACT

Since a piezoelectric element that changes a volume of a pressure generating chamber through a vibrating plate, changes a flow passage cross-sectional area of an ink supplying passage through the vibrating plate, it is possible that according to a volume variation of the pressure generating chamber, the flow passage cross-sectional area of the ink supplying passage is changed and a flow rate of the ink which flows between a reservoir and the pressure generating chamber is controlled. Therefore, when the ink that is filled within the pressure generating chamber is ejected from a nozzle opening that communicates with the pressure generating chamber, the amount of the ink returned to the reservoir via the ink supplying passage can be decreased, ejection quantity of ink can be ensured, and an ink jet type recording head which limits the decrease of ejection performance, can be obtained.

This application claims a priority to Japanese Patent Application No. 2010-003448 filed on Jan. 9, 2010 which is hereby expressly incorporated by reference herein in its entirety.

### BACKGROUND

1. Technical Field

The present invention relates to the liquid ejecting head and the liquid ejecting apparatus which increase the pressure in a pressure generating chamber by using deformation of a piezoelectric element and eject the liquid in the pressure generating chamber.

2. Related Art

A liquid ejecting head in which a portion of a pressure generating chamber is configured by a vibrating plate, the piezoelectric element is formed on a vibrating plate, and the piezoelectric element is deformed, in order to deform the vibrating plate and eject the liquid in the pressure generating chamber, and the liquid ejecting apparatus that includes the liquid ejecting head, are known.

The piezoelectric element has a piezoelectric body interposed between a lower electrode and an upper electrode. By voltage being applied between the lower electrode and the upper electrode, the piezoelectric element is driven and deformed.

In an ink jet type recording head as a liquid ejecting head, a piezoelectric vibrator as the piezoelectric element is deformed so that the volume of the pressure generating chamber is increased and the pressure generating chamber is filled with ink via an ink supplying passage as a liquid supplying passage from a reservoir of ink as liquid. Thereafter, if the pressure of the pressure generating chamber is increased in order to decrease the volume of the pressure generating chamber, the ink filled within the pressure generating chamber is ejected from a nozzle opening that communicates with the pressure generating chamber. In this case, it is known that the ink supplying passage is formed with a smaller width than width of the pressure generating chamber so that a flow passage resistance of ink which flows into the pressure generating chamber is maintained constantly (refer to, for example, JP-A-2009-220507: 4 page, and FIGS. 1 and 2).

Although the liquid supplying passage is formed with a smaller width than the width of the pressure generating chamber and the flow passage resistance of liquid which flows into the pressure generating chamber is maintained constantly, when liquid filled within the pressure generating chamber is ejected from the nozzle opening that communicates with the pressure generating chamber, the liquid that is returned into the reservoir through the liquid supplying passage still remains, the ejection quantity is decreased by the return quantity of liquid, and then the ejection performance of the liquid ejecting head is decreased.

### SUMMARY

The invention has been made in view of the above problems, and the above problems can be solved by the following configuration or the following application example.

### Application 1

According to an aspect of the invention, there is provided a liquid ejecting head including: a pressure generating chamber that communicates with a nozzle opening for ejecting liquid; a liquid supplying passage that communicates with the pressure generating chamber and a reservoir in which the liquid stored; and a piezoelectric element that changes the volume of the pressure generating chamber and a flow passage cross-sectional area of the liquid supplying passage by a vibrating plate.

According to the aspect of the invention, since there is provided the piezoelectric element that changes the flow passage cross-sectional area of the liquid supplying passage using the vibrating plate, in addition to the piezoelectric element that changes the volume of the pressure generating chamber using the vibrating plate, it is possible that according to the change of the volume of the pressure generating chamber, the flow passage cross-sectional area of the liquid supplying passage is changed and the flow rate of liquid that flows between the reservoir and the pressure generating chamber is controlled. Therefore, when the liquid filled within the pressure generating chamber is ejected from the nozzle opening that communicates with the pressure generating chamber, it is possible that the quantity of liquid which is returned into the reservoir via the liquid supplying passage is decreased and the quantity of liquid ejected is ensured, so that the liquid ejecting head which limits the a decrease in the ejection performance is obtained.

### Application 2

In the liquid ejecting head, it is preferable that the pressure generating chamber and the liquid supplying passage include a nozzle plate which is provided at least on a passage forming substrate and the nozzle opening.

In this case, it is preferable that the pressure generating chamber and the liquid supplying passage include at least a passage forming substrate and the nozzle plate which are the same member. Therefore, since the pressure generating chamber and the liquid supplying passage are continuously formed, it is possible that the liquid ejecting head, which enables the flow passage cross-sectional area of the liquid supplying passage to be controlled by the shape of the passage forming substrate and the nozzle plate, is obtained.

### Application 3

In the liquid ejecting head, it is preferable that the nozzle plate includes a projection portion which determines the cross-sectional area of the liquid supplying passage.

In this case, because the cross-sectional area of the liquid supplying passage is determined by the projection portion of the nozzle plate, it is possible to obtain a liquid ejecting head which enables the flow passage cross-sectional area to be controlled by the projection portion.

### Application 4

In the liquid ejecting head, it is preferable that the vibrating plate and the piezoelectric element are integrated with each other over the pressure generating chamber and the liquid supplying passage. In this case, because the vibrating plate and the piezoelectric element are integrated with each other, it is possible to obtain the liquid ejecting head which has the simple structure and can easily control the piezoelectric element.

### Application 5

In the liquid ejecting head, it is preferable that the piezoelectric element includes a first piezoelectric element which changes the volume of the pressure generating chamber and a second piezoelectric element which changes the flow passage cross-sectional area of the liquid supplying passage.

In this case, because the piezoelectric element is divided into the first piezoelectric element which changes the volume of the pressure generating chamber and the second piezoelectric element which changes the flow passage cross-sectional area of the liquid supplying passage, it is possible for the volume and the flow passage cross-sectional area to be separately controlled by each piezoelectric element and the flow rate of liquid which flows between a reservoir and the pressure generating chamber is more adequately controlled. Therefore, when liquid filled in the pressure generating chamber is ejected from a nozzle opening that communicates with the pressure generating chamber, because the quantity of liquid that returned into the reservoir via the liquid supplying passage is able to be further decreased and the quantity of liquid ejected is further ensured, it is possible that the liquid ejecting head in which a decrease in ejection performance is further suppressed, is obtained.

### Application 6

In the liquid ejecting head, it is preferable that the vibrating plate includes a first vibrating plate and a second vibrating plate, the first vibrating plate defines a portion of the pressure generating chamber and the first piezoelectric element is provided on the first vibrating plate, and the second vibrating plate defines a portion of the nozzle plate, and the second piezoelectric element is provided on a side of surface which is the opposite side of the flow passage substrate, of surfaces of the second vibrating plate.

In this case, because in addition to the first vibrating plate that corresponds to the first piezoelectric element and defines a portion of the pressure generating chamber, the nozzle plate includes the second vibrating plate that corresponds to the second piezoelectric element and is different from the first vibrating plate, it is possible for the second vibrating plate according to the vibrating performance of the second piezoelectric element which changes the flow passage cross-sectional area of the liquid supplying passage to be used. Therefore, when liquid that is filled within the pressure generating chamber is ejected from the nozzle opening that communicates with the pressure generating chamber, since the quantity of liquid which is returned into the reservoir via the liquid supplying passage is further decreased and the quantity of the liquid ejected is further ensured, it is possible that the liquid ejecting head in which a decrease in ejection performance is further suppressed, is obtained.

### Application 7

According to another aspect of the invention, there is provided a liquid ejecting apparatus that includes the above described liquid ejecting head.

In this case, it is possible that the liquid ejecting apparatus which has the effects described above is obtained.

### BRIEF DESCRIPTION OF THE DRAWINGS

The invention will be described with reference to the accompanying drawings, wherein like numbers reference like elements.

FIG. 1 is a schematic view illustrating an example of an ink jet type recording apparatus according to a first embodiment.

FIG. 2 is an exploded perspective view schematically illustrating an ink jet type recording head.

FIG. 3A is a schematic plan view illustrating a part of an ink jet type recording head and FIG. 3B is a schematically cross-sectional view taken along line IIIB-IIIB of FIG. 3A.

FIG. 4 is a schematically and partially cross-sectional view taken along line IV-IV of FIG. 3A of an ink jet type recording head.

FIG. 5 is a schematically cross-sectional view taken along line V-V of FIG. 3A in a case where a piezoelectric body is flexibly deformed.

FIG. 6 is a schematically and partially cross-sectional view taken along line VI-VI of FIG. 3A in a case where the piezoelectric body is flexibly deformed.

FIG. 7 is an exploded perspective view schematically illustrating an ink jet type recording head according to a second embodiment.

FIG. 8A is a schematic plan view illustrating a part of an ink jet type recording head and FIG. 8B is a schematically cross-sectional view taken along line VIIIB-VIIIB of FIG. 8A.

FIG. 9 is a schematically cross-sectional view taken along line IX-IX of FIG. 8A in a case where the piezoelectric body is flexibly deformed.

FIGS. 10A and 10B are a view illustrating the driving waveforms of a first piezoelectric element and a second piezoelectric element, respectively.

FIG. 11 is an exploded perspective view schematically illustrating an ink jet type recording head according to a third embodiment.

FIG. 12A is a schematic plan view illustrating a part of an ink jet type recording head and FIG. 12B is a schematically cross-sectional view taken along line XIIB-XIIB of FIG. 12A.

FIG. 13 is a schematically and partially cross-sectional view taken along line XIII-XIII of FIG. 12A in which the ink jet type the recording head is shown.

FIG. 14 is a schematically cross-sectional view taken along line XIV-XIV of FIG. 12A in a case where a piezoelectric element is flexibly deformed.

FIG. 15 is a schematically and partially cross-sectional view taken along line XV-XV of FIG. 12A in a case where a piezoelectric element is flexibly deformed.

FIG. 16A is a schematic partial cross-sectional view taken along line XVIA-XVIA of FIG. 3A in which the ink jet type recording head is shown as modified example and FIG. 16B is a schematic partial cross-sectional view taken along line XVIB-XVIB of FIG. 3A in a case where the piezoelectric body is flexibly deformed.

### DESCRIPTION OF EXEMPLARY EMBODIMENTS

Hereinafter, preferred embodiments of the invention will be described in detail with reference to the accompanying drawings.

### First Embodiment

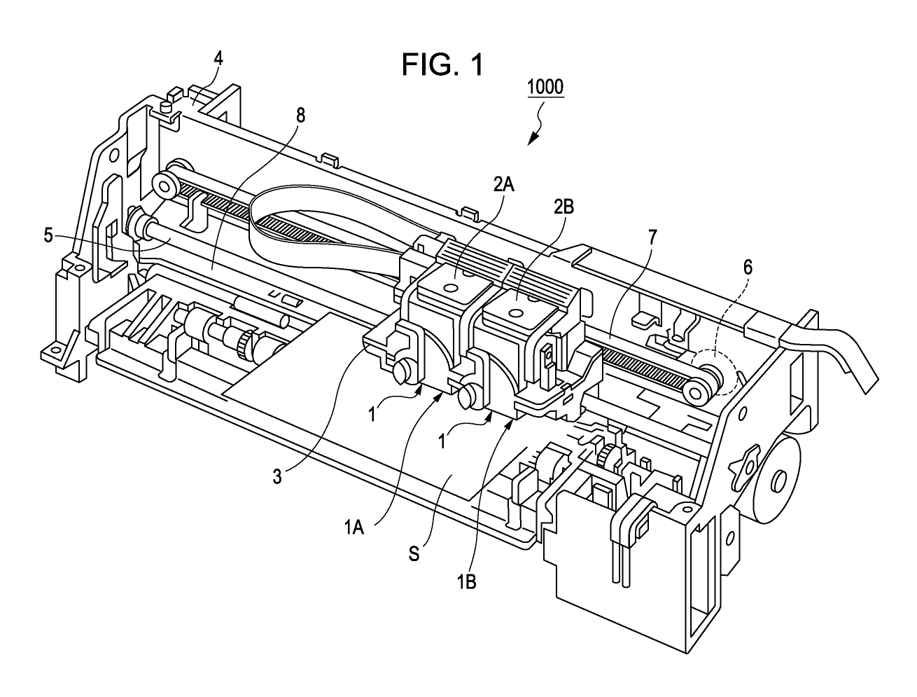

FIG. 1 is a schematic view illustrating an example of an ink jet type recording apparatus 1000 as a liquid ejecting apparatus according to the first embodiment. The ink jet type recording apparatus 1000 is such an apparatus that ink as the liquid is ejected onto the recording sheets as recording medium in order to record.

In FIG. 1, an ink jet type recording apparatus 1000 is provided with recording head units 1A and 1B having an ink jet type recording head 1 as the liquid ejecting head. Cartridges 2A and 2B which configure an ink supplying means are detachably provided on the recording head units 1A and 1B.

In this case, the ink jet type recording head 1 is provided on the opposite side to a recording sheet S of the recording head units 1A and 1B and is not shown in FIG. 1.

A carriage 3 on which the recording head units 1A and 1B are mounted, is provided on a carriage shaft 5 movably mounted on a apparatus body 4 in the axial direction of the carriage shaft 5. The recording head units 1A and 1B act to discharge, for example, black and color ink compositions, respectively.

The driving force of a drive motor 6 is transferred to the carriage 3 via a plurality of gears (not shown) and a timing belt 7, and the carriage 3 on which the recording head units 1A and 1B are mounted, moves along the carriage shaft 5.

Meanwhile, a platen 8 is provided in the apparatus body 4 along the carriage 3. The platen 8 is arranged so as to be rotated by the driving force of a paper feed motor (not shown), and a recording sheet S which is a recording medium, such as a sheet or the like, fed by paper feeding rollers or the like, is arranged so as to be wound around the platen 8 and transported.

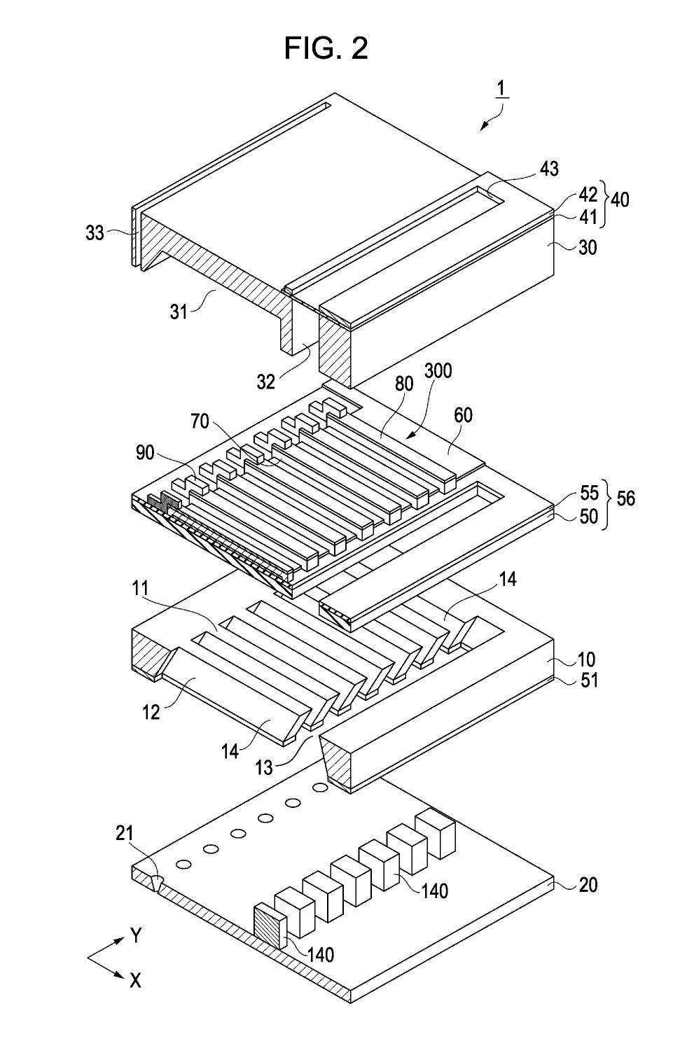

Hereinafter, an ink jet type recording head 1 will be described in detail with reference to FIGS. 2, 3 and 4.

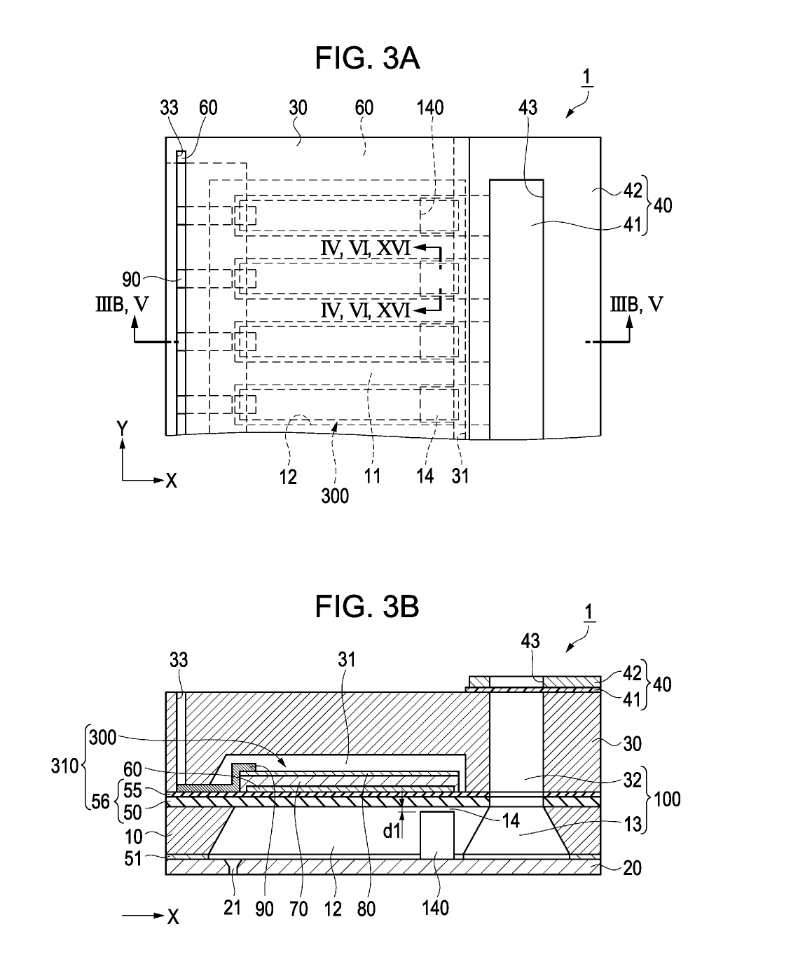

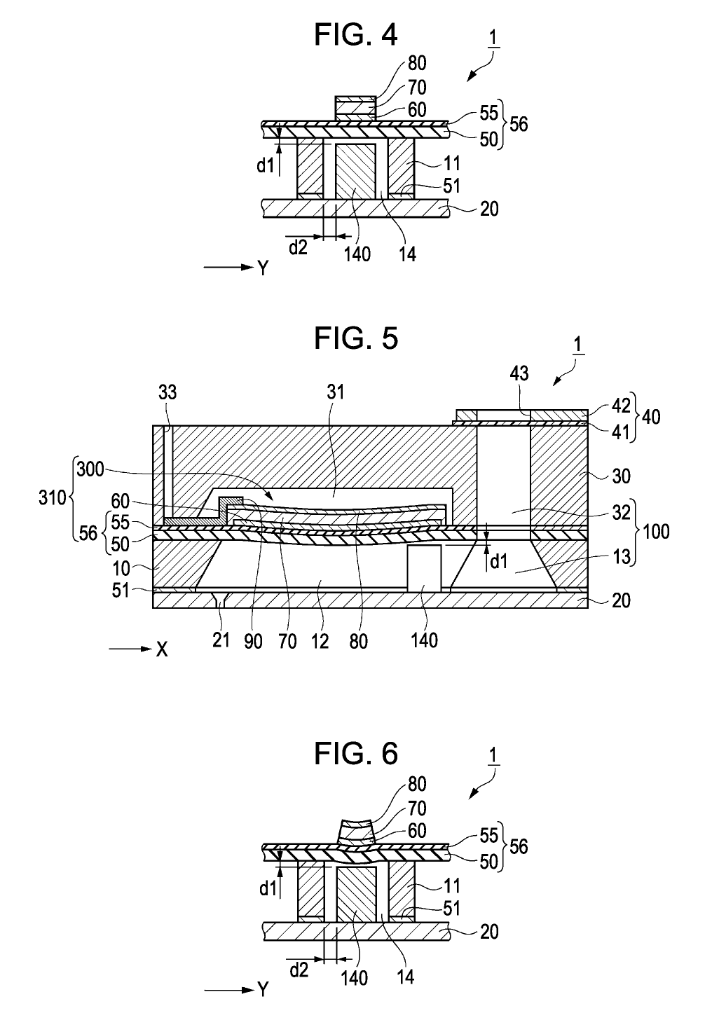

FIG. 2 is an exploded perspective view schematically illustrating the ink jet type recording head 1, FIG. 3A is a schematic and partial plan view illustrating the ink jet type recording head 1, and FIG. 3B is a schematically cross-sectional view taken along line IIIB-IIIB of FIG. 3A. Also, FIG. 4 is a schematically and partially cross-sectional view taken along line IV-IV of FIG. 3A.

In FIGS. 2, 3 and 4, the ink jet type recording head 1 is provided with a flow passage forming substrate 10, a nozzle plate 20 and a protection substrate 30.

The flow passage forming substrate 10, for example, is made of a silicon single-crystal substrate of a plane direction (110). An elastic film 50 is formed on its one surface, and the elastic film 50 is made of silicon oxide formed in advance by thermal oxidation and has a thickness of 0.50 μm to 2.00 μm.

By anisotropic-etching the silicon single-crystal substrate on a surface facing the surface on which the elastic film 50 is formed, a pressure generating chamber 12 defined by a plurality of partition walls 11 is arranged in the flow passage forming substrate 10 in a plurality of rows wherein the elastic film 50 acts as a etching stopper.

A communication portion 13 that communicates with a reservoir portion 32 described below of the protection substrate 30 is also formed on an outside of one end of a direction (the longitudinal direction and X axis direction) perpendicular to a row arrange direction (the width direction and Y axis direction) of the pressure generating chamber 12. The communication portion 13 also communicates with one end of the longitudinal direction of each pressure generating chamber 12 via an ink supplying passage 14 as each liquid supplying passage.

On a surface facing the surface on which the elastic film 50 of the flow passage forming substrate 10 is formed, a mask film 51 is arranged, when the pressure generating chamber 12 is formed, and on the mask film 51, the nozzle plate 20 in which a nozzle opening 21 that communicates with an end vicinity of opposite side to the ink supplying passage 14 of each pressure generating chamber 12 is formed, is attached by an adhesive, a thermal-welding film, or the like.

The ink supplying passage 14 is enclosed and defined by the elastic film 50, partition walls 11 which is a part of the flow passage forming substrate 10, and the nozzle plate 20.

A flow rate control portion 140 is formed as a projection portion in the nozzle plate 20. When the flow passage forming substrate 10 and the nozzle plate 20 are assembled to each other, the flow rate control portion 140 is arranged in the ink supplying passage 14. Therefore, the flow rate control portion 140 determines the flow passage cross-sectional area of the ink supplying passage 14.

It is possible for the flow rate control portion 140 to be integrated with the nozzle plate 20, or separate from it.

Between the flow rate control portion 140 and the elastic film 50, a gap of distance d1 is formed, and between the flow rate control portion 140 and the partition walls 11, a gap of distance d2 is formed.

The gap of distance d1 and the gap of distance d2 are determined by the volume or the like of the pressure generating chamber 12. For example, in a case where the volume of the pressure generating chamber 12 is 700 μm (length of a X axis direction)×58 μm (length of a Y axis direction)×70 μm (length of a direction perpendicular to X axis and Y axis), it is desirable that a length of the ink supplying passage 14 in X axis direction is set as 10 μm to 20 μm, the distance d1 is set as 1 μm to 4 μm and the distance d2 is set as 1 μm to 4 μm.

If each of the distance d1 and the distance d2 is set as 2 μm, the flow passage cross-sectional area of the ink supplying passage 14 is about 2×(2 μm×(70 μm−2 μm)+(2 μm×58 μm)=388 μm.

Meanwhile, on the elastic film 50 of the opposite surface to the surface on which the nozzle plate 20 of the flow passage forming substrate 10 is attached, an insulation body film 55 having a thickness which is, for example, about 0.40 μm, is formed, and on the insulation body film 55, a lower electrode 60 having a thickness of, for example, about 0.20 μm, a piezoelectric body 70 having a average thickness of, for example, about 0.80 μm and an upper electrode 80 having a thickness of, for example, about 0.05 μm are layered and formed, so as to configure a piezoelectric element 300.

The piezoelectric element 300 is mentioned as a part which includes the lower electrode 60, the piezoelectric body 70 and the upper electrode 80. The piezoelectric element 300 is generally configured in such a manner that any one electrode of the piezoelectric element 300 is a common electrode and the other electrode and the piezoelectric body 70 are configured by patterning with respect to each pressure generating chamber 12, wherein any one of patterned parts is configured by one electrode and the piezoelectric body 70, and a portion in which a piezoelectric distortion is generated by applying a voltage to both electrodes, acts as an active portion of the piezoelectric body. In any case, the active portion of the piezoelectric body is formed in each pressure generating chamber 12.

In the present embodiment, the elastic film 50 and the insulation body film 55 act as a vibrating plate 56 and then a deformation is generated by the driving of the piezoelectric element 300. The vibrating plate 56 is integrally formed over a zone which ranges from the pressure generating chamber 12 to the ink supplying passage 14.

In this case, a portion which includes, the piezoelectric element 300 and the vibrating plate 56 including a section in which the deformation is generated by the driving of the piezoelectric element 300, is called as an actuator apparatus 310.

Also, it is possible that the vibrating plate is configured by the lower electrode 60 only. In this case, the piezoelectric element 300 is the actuator apparatus.

It is possible that the elastic film 50 which configures the vibrating plate 56, and the insulation body film 55, are configured by a layered body which is of a layer any of at least one selected from not only silicon oxide but also for example zirconium oxide or aluminum oxide, or layers thereof.

It is possible that the elastic film 50 which configures the vibrating plate 56, and the insulation body film 55 can be formed by a sputtering method, a vacuum deposition method, a CVD method, or the like.

The vibrating plate 56 has a function that is vibrated by the driving of the piezoelectric element 300. The vibrating plate 56 is deformed by activation of the piezoelectric element 300 and changes the volume of the pressure generating chamber 12. If the volume of the pressure generating chamber 12 filled with ink is decreased, the pressure within the pressure generating chamber 12 is increased and ink droplets are then ejected through the nozzle opening 21 of the nozzle plate 20.

The piezoelectric element 300 is integrally formed to range from the vibrating plate 56 that configures a part of the pressure generating chamber 12 to the vibrating plate 56 that configures a part of the ink supplying passage 14. In particular, the piezoelectric element 300 is formed up to an opposite portion to a flow rate control portion 140, with the vibrating plate 56 being interposed.

Without limitation to materials as long as it has conductive properties, for example, various metals such as nickel, iridium, platinum, or the like, conductive oxides thereof (for example, iridium oxide, or the like), complex oxides of strontium and ruthenium, complex oxides of lanthanum and nickel, or the like, can be used as material for the lower electrode 60.

After a layer of a conductive body is formed on all surfaces of the elastic film 50 and the insulation body film 55 by a sputtering method, a vacuum deposition method, a CVD method, or the like, the lower electrode 60 can be patterned by photolithography and be formed. Also, it is possible that the lower electrode 60 is formed by a method for which the patterning is not necessary, such as a print method or the like.

The thickness of the lower electrode 60 can be set as, for example, 0.10 μm to 0.30 μm. It is possible that the lower electrode 60 has one layer, which is of the above described material, or a plurality of layers, which are of above described materials.

The lower electrode 60 makes a pair with the upper electrode 80, and act as an electrode disposed to one side of the piezoelectric body 70 interposed between them. It is possible that the lower electrode 60 is a common electrode of a plurality of piezoelectric element 300. The lower electrode 60 can be electrically connected with a drive circuit which is an external circuit (not shown).

For the piezoelectric body 70, a perovskite type of oxide generally expressed as ABO₃ can be used preferably. Specifically, lead zirconate titanate (Pb(Zr,Ti)O₃) (hereinafter, called “PZT”), lead zirconate titanate niobate (Pb(Zr,Ti,Nb)O₃) (hereinafter, called “PZTN” (registered trademark)), and barium titanate (BaTiO₃), niobate potassium sodium ((K,Na)NbO₃), or the like, are cited as examples.

The piezoelectric body 70 is elastically deformed by an voltage being applied by the lower electrode 60 and the upper electrode 80, and can provide mechanical output. It is preferable that the PZT and the PZTN (registered trademark) are used as the material of the piezoelectric body 70 because these materials are superior especially in the piezoelectric performance.

The piezoelectric body 70 can be formed by a sol-gel method, a CVD method, or the like. In the sol-gel method, a series of processes such as raw material solution coating, preheating, and crystallization annealing may be repeated several times to obtain a predetermined film thickness.

For example, in a case where the PZT is formed, the sol-gel solution which includes Pb, Zr, and Ti, is used, so that the PZT can be formed by a spin coat method, a print method, or the like. The thickness of the piezoelectric body 70 can be set as 0.50 μm to 1.50 μm.

As the material of the upper electrode 80, various metals such as nickel, iridium, platinum, or the like, conductive oxide thereof (for example, iridium oxide, or the like), complex oxide of strontium and ruthenium, complex oxide of lanthanum and nickel, or the like, such as the material of the lower electrode 60, can be used. The upper electrode 80 can be formed by using a sputtering method, a vacuum deposition method, or a photolithography process. The thickness of the upper electrode 80 can be set as, for example, 0.05 μm to 0.50 μm.

As shown in FIGS. 2 and 3, in the piezoelectric element 300, the lead electrode 90 is electrically connected to the upper electrode 80. For example, the lead electrode 90 can be electrically connected and extended to the upper electrode 80.

In a case where the piezoelectric element 300 has a protection film, it is possible that a through hole is formed in the protection film and thereby the upper electrode 80 and the lead electrode 90 are connected to each other.

A protection substrate 30 having a piezoelectric element holding portion 31 which is able to secure such a space as not to block a movement in the opposite region to the piezoelectric element 300, is joined to the side of the piezoelectric element 300 of the flow passage forming substrate 10 by adhesive. Since the piezoelectric element 300 is formed within the piezoelectric element holding portion 31, the piezoelectric element 300 can be covered in a state where it is almost unaffected by the exterior environment.

In the piezoelectric element holding portion 31, the space may be sealed or may not be sealed.

Also, a reservoir portion 32 is provided in the protection substrate 30. The reservoir portion 32 configures a reservoir 100 which is formed as a common ink chamber of each pressure generating chamber 12 that communicates with a communication portion 13 of the flow passage forming substrate 10.

Also, in the region in which the lead electrode 90 of the protection substrate 30 is provided, a through hole 33 which is penetrated in a thickness direction of the protection substrate 30 is provided. The end area of the lead electrode 90 drawn out of each piezoelectric element 300 is exposed into the through hole 33.

The drawn out lead electrode 90 is connected to the circuit element (not shown) or the like, via the through hole 33.

Furthermore, onto such a protection substrate 30, a compliance substrate 40 which includes a sealing film 41 and a fixing plate 42, is joined. The fixing plate 42 is also formed from a hard material such as metal or the like. Since in a region of the fixing plate 42 that faces the reservoir 100 is formed an opening portion 43 which is entirely removed in the thickness direction, one side of the reservoir 100 is sealed only by the sealing film 41 which is flexible.

For example, the ink jet type recording head 1, the piezoelectric element 300 and the actuator apparatus 310 can be obtained as a plurality of ink jet type recording heads 1, piezoelectric elements 300 and actuator apparatuses 310, by forming the piezoelectric body 70, the upper electrode 80, the lead electrode 90, and the like, in the wafer state and by finally dividing them in the wafer state.

In FIG. 5 is shown a schematically cross-sectional view taken along line V-V of FIG. 3A in a case where the piezoelectric element 300 which includes the piezoelectric body 70 is flexibly deformed in the direction of each pressure generating chamber 12, and in FIG. 6 is shown a schematically and partially cross-sectional view taken along line VI-VI of FIG. 3A. The state of flexural deformation is largely shown in the figures.

According to a drive signal from the drive circuit (not shown), a drive voltage is applied between the lower electrodes 60 and the upper electrodes 80 corresponding to the pressure generating chamber 12, the elastic film 50, the insulation body film 55, the lower electrode 60 and the piezoelectric body 70 are flexibly deformed, and thus pressure within each pressure generating chamber 12 is increased in order that the ink droplets are ejected from the nozzle opening 21.

At this time, the gap between the flow rate control portion 140 and the elastic film 50 narrows by flexural deformation of the piezoelectric body 70, and the flow rate control portion 140 and the elastic film 50 are contacted to each other, or the distance d1 shortens. In FIG. 5 and FIG. 6, a case is shown where the distance d1 shortens.

When flexural deformation of the piezoelectric element 300 that includes the piezoelectric body 70 is returned, in the ink jet type recording head 1, the ink flows from an outer ink supplying means (not shown), and therefore the interior from the reservoir 100 to the nozzle opening 21 is filled with the ink.

At this time, the gap of the distance d1 between the flow rate control portion 140 and the elastic film 50 that forms the ink supplying passage 14 widens by flexural deformation of the piezoelectric element 300 that includes the piezoelectric body 70 so as to be returned to the original value.

By the above described embodiment, the following effects are obtained.

(1) Since the piezoelectric element 300 that changes the volume of the pressure generating chamber 12 through the vibrating plate 56, changes a flow passage cross-sectional area of the ink supplying passage 14 through the vibrating plate 56, it is possible that according to the volume variation of the pressure generating chamber 12, the flow passage cross-sectional area of the ink supplying passage 14 is changed and the flow rate of the ink which flows between the reservoir 100 and the pressure generating chamber 12 is controlled. Therefore, when the ink that is filled within the pressure generating chamber 12 is ejected from the nozzle opening 21 that communicates with the pressure generating chamber 12, the amount of the ink returned to the reservoir 100 via the ink supplying passage 14 can be decreased, ejection quantity of ink can be ensured, and the ink jet type recording head 1 which limits the decrease of ejection performance, can be obtained.

(2) The pressure generating chamber 12 and the ink supplying passage 14 are configured by the flow passage forming substrate 10 and the nozzle plate 20 with at least the same material as them. Therefore, it is possible that the pressure generating chamber 12 and the ink supplying passage 14 is continuously formed, and the ink jet type recording head 1 in which the flow passage cross-sectional area of the ink supplying passage 14 can be controlled by the shapes of the flow passage forming substrate 10 and the nozzle plate 20 can be obtained.

(3) Since the flow passage cross-sectional area of the ink supplying passage 14 is determined by the flow rate control portion 140 of the nozzle plate 20, it is possible that the ink jet type recording head 1 in which the flow passage cross-sectional area can be controlled by the flow rate control portion 140, can be obtained.

(4) Since the vibrating plate 56 and the piezoelectric element 300 are integrally formed with each other, it is possible that the structure is simple and the ink jet type recording head 1 in which the control of the piezoelectric element 300 is easy, is obtain.

(5) It is possible that the ink jet type recording apparatus 1000 which has the above described effects, is obtain.

### Second Embodiment

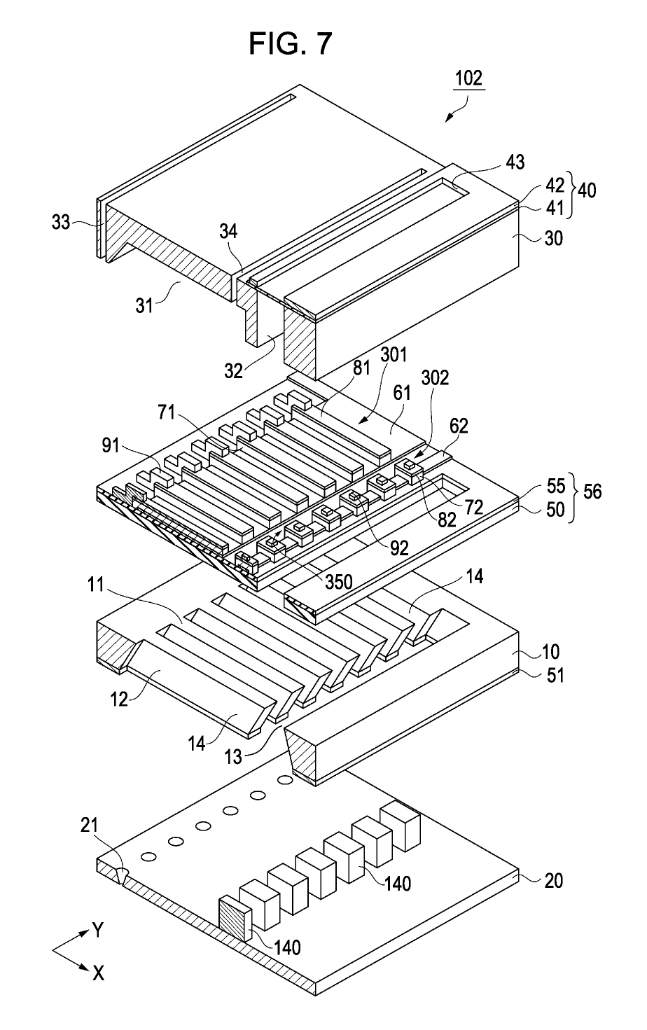

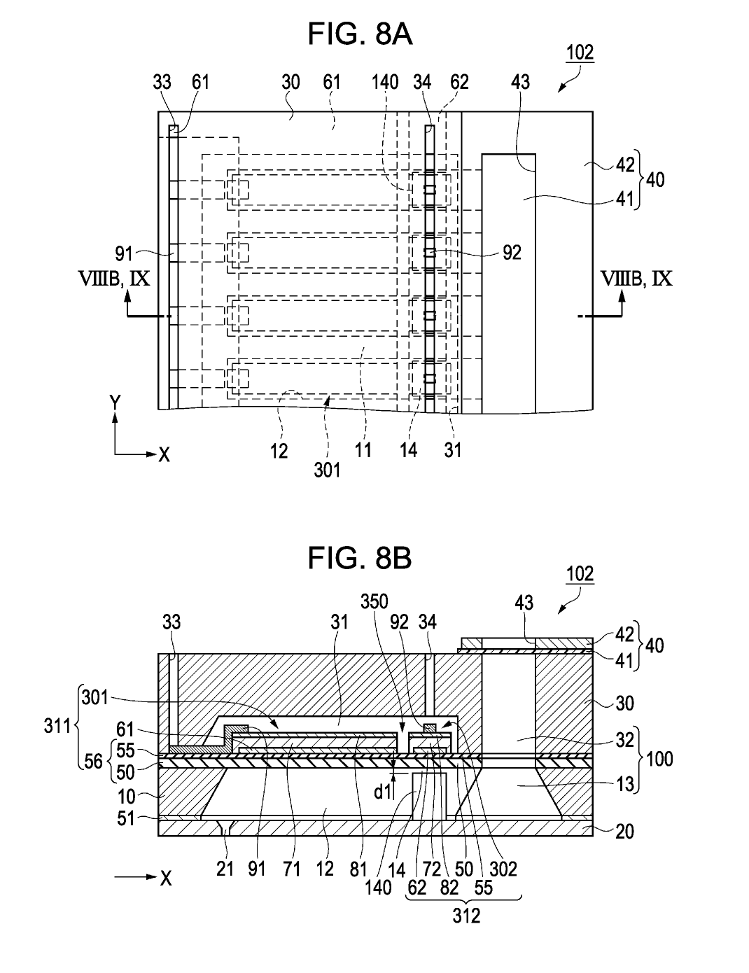

In FIG. 7 is shown an exploded perspective view schematically illustrating an ink jet type recording head 102 is shown according to the second embodiment, in FIG. 8A, is shown a plane view schematically and partially illustrating the ink jet type recording head 102 is shown, and in FIG. 8B, is shown a schematically cross-sectional view taken along line VIIIB-VIIIB of FIG. 8A is shown. Similar constituent elements of the second embodiment as elements of the first embodiment are given the same reference numerals.

Configuration of the piezoelectric element 300 and the actuator apparatus 310 and the structure of the protection substrate 30 are different from the first embodiment.

The piezoelectric element of the present embodiment is provided with a first the piezoelectric element 301 and a second the piezoelectric element 302, and the actuator apparatus is provided with a first actuator apparatus 311 and a second actuator apparatus 312.

The vibrating plate 56 is formed in the same manner as the first embodiment. The first actuator apparatus 311 is provided with the first piezoelectric element 301 and the vibrating plate 56 that includes a portion in which the deformation is generated by the driving of the first piezoelectric element 301, and the second actuator apparatus 312 is provided with a second piezoelectric element 302 and a vibrating plate 56 that includes a portion in which the deformation is generated by the driving of the second piezoelectric element 302.

The first piezoelectric element 301 is formed up to a portion of the vibrating plate 56 that forms a part of the pressure generating chamber 12, with a gap 350 being emptied, and therefore the second piezoelectric element 302 is formed on a portion of the vibrating plate 56 opposite to the flow rate control portion 140.

The first piezoelectric element 301 is provided with a lower electrode 61, a piezoelectric body 71 and an upper electrode 81. Also, the second piezoelectric element 302 is provided with a lower electrode 62, a piezoelectric body 72 and an upper electrode 82. It is possible that the lower electrodes 61 and 62, the piezoelectric bodies 71 and 72 and the upper electrodes 81 and 82 are made and formed with the same material and method as the material and method of the lower electrode 60, the piezoelectric body 70 and the upper electrode 80 of the first embodiment, respectively.

A lead electrode 91 is provided in the upper electrode 81, and the lead electrode 91 is connected to an external drive circuit (not shown) via the through hole 33.

Meanwhile, in the upper electrode 82 is provided a lead electrode 92, the lead electrode 92 is connected to an external drive circuit (not shown) via through hole 34 that forms in the protection substrate 30.

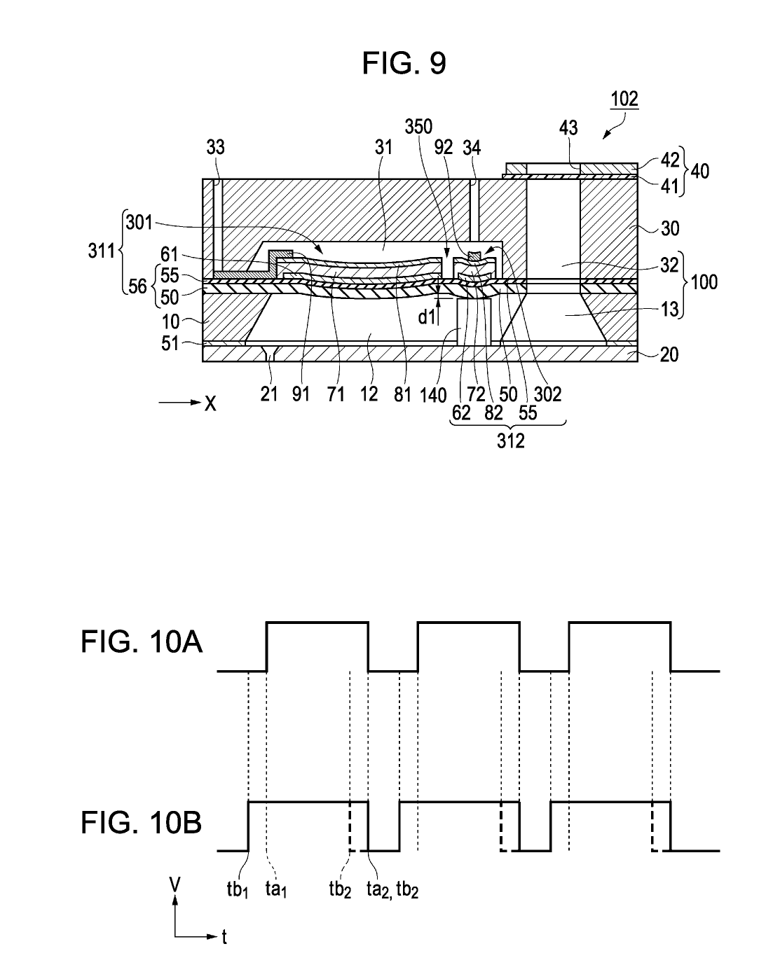

In FIG. 9 is shown a schematically cross-sectional view taken along line IX-IX of FIG. 8A in a case where the first and second piezoelectric elements 301 and 302 are flexibly deformed in the direction of each pressure generating chamber 12. The state of the deforming flexibility is largely as shown in the figures of the first embodiment.

According to a drive signal from a drive circuit (not shown), the first piezoelectric element 301 and the first actuator apparatus 311, and the second piezoelectric element 302 and the second actuator apparatus 312 are separately driven.

In FIG. 9, the gap between the flow rate control portion 140 and the elastic film 50 that forms the ink supplying passage 14 shortens by the flexural deformation of the second piezoelectric element 302, and therefore the flow rate control portion 140 and the elastic film 50 are contacted to each other or the distance d1 shortens. In FIG. 9, a case where the flow rate control portion 140 and the elastic film 50 are contacted to each other is shown.

For example, FIG. 10 is a view illustrating a driving waveform of the first piezoelectric element 301 and the first actuator apparatus 311, and the second piezoelectric element 302 and the second actuator apparatus 312. FIG. 10A is a view illustrating a driving waveform of the first piezoelectric element 301 and the first actuator apparatus 311 and FIG. 10B is a view illustrating a driving waveform of the second piezoelectric element 302 and the second actuator apparatus 312. A horizontal axis shows the time t and a vertical axis shows the drive voltage V.

In FIG. 10, the second piezoelectric element 302 and the second actuator apparatus 312 start the drive at a time tb₁ prior to a time ta₁ at which the first piezoelectric element 301 and the first actuator apparatus 311 start the drive. Therefore, total cross-sectional area of the flow passage of the flow rate control portion 140 is decreased.

After the cross-sectional area of the flow passage of the flow rate control portion 140 is decreased, the ejection of the ink droplets is started at the drive start time ta₁ of the first piezoelectric element 301 and the first actuator apparatus 311, and in the near future, the ejection is finished.

Meanwhile, it is desired that the drive end time tb₂ of the second piezoelectric element 302 and the second actuator apparatus 312 is prior to or simultaneous with, the drive finish time ta₂ of the first piezoelectric element 301 and the first actuator apparatus 311.

It is desired that when the flexural deformation of the piezoelectric body 71 is restored and ink flows in from the external ink supply means (not shown), the distance d1 of the gap between the flow rate control portion 140 and the elastic film 50 is restored to original value, by restoring the flexural deformation of the piezoelectric body 72, as shown in FIG. 9 and the ink supplying passage 14, which is necessary for inflow of ink, is ensured.

Through the above described second embodiment, the following effects are obtained in addition to the effects of the first embodiment.

(6) The piezoelectric element is divided into the first piezoelectric element 301 that changes the volume of the pressure generating chamber 12 and the second piezoelectric element 302 that changes the cross-sectional area of flow passage of the ink supplying passage 14. It is possible that each piezoelectric element enables control by dividing the volume and the flow passage cross-sectional area and the flow rate of ink flowing between the reservoir 100 and the pressure generating chamber 12 is more adequately controlled. Therefore, when the ink filled within the pressure generating chamber 12 is ejected from the nozzle opening 21 that communicates with the pressure generating chamber 12, it is possible that the quantity of ink which returns into the reservoir 100 through the ink supplying passage 14 is further decreased, the ejection quantity of ink is further ensured, and the ink jet type recording head 102 in which the decrease of ejection performance can be further suppressed, is obtained.

### Third Embodiment

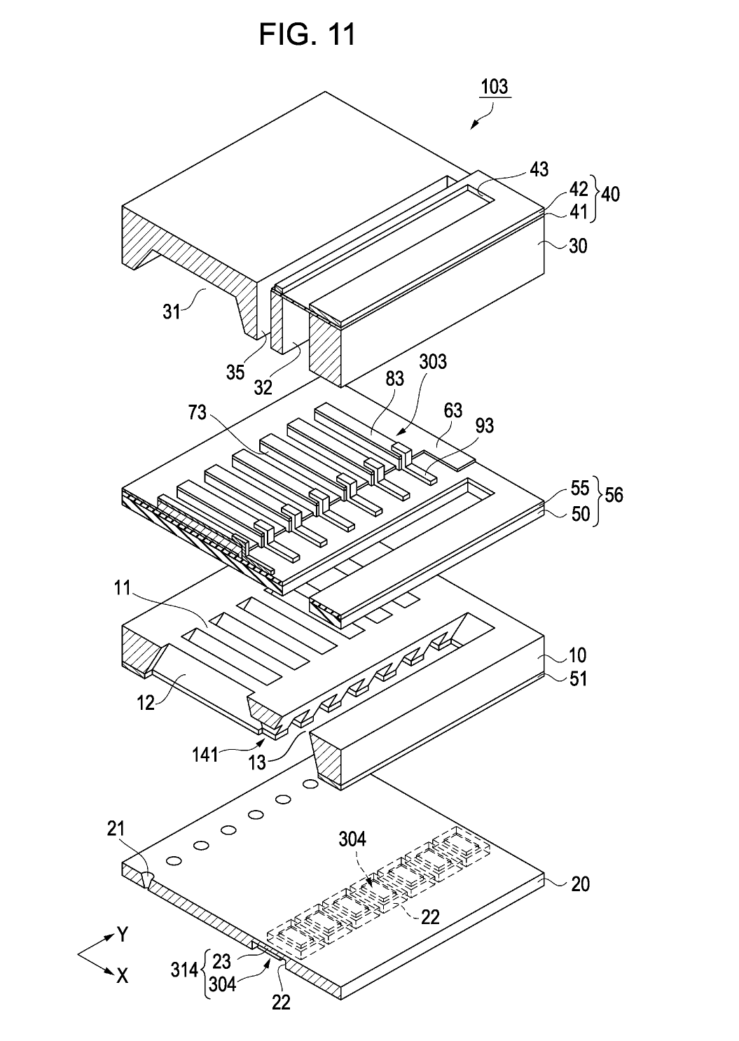

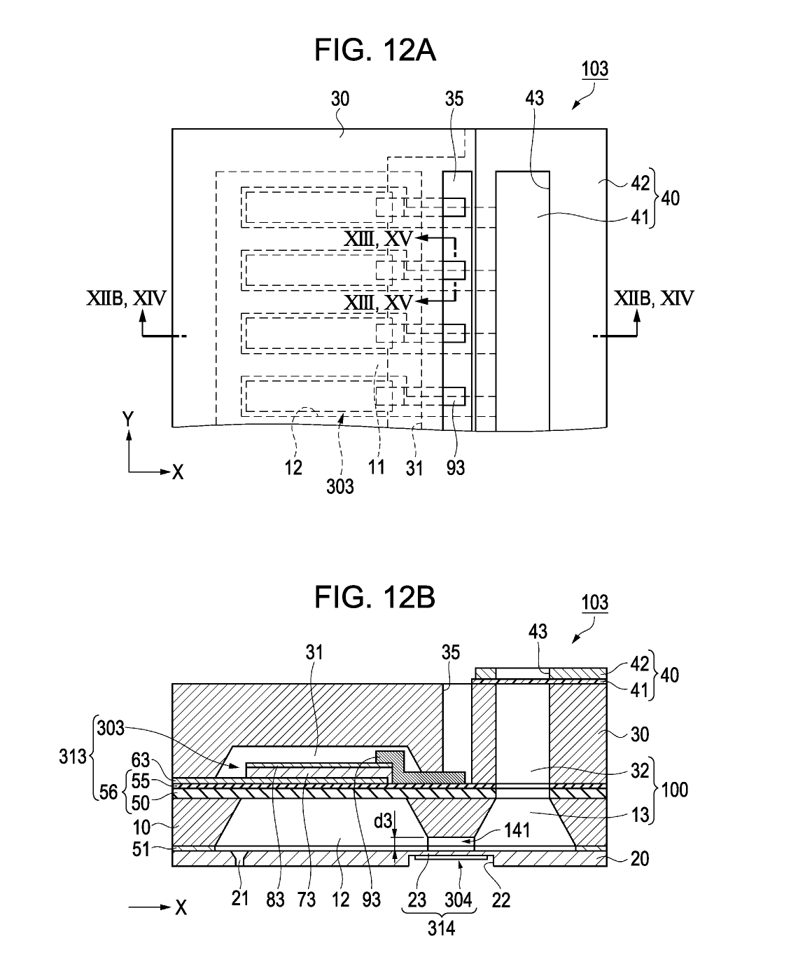

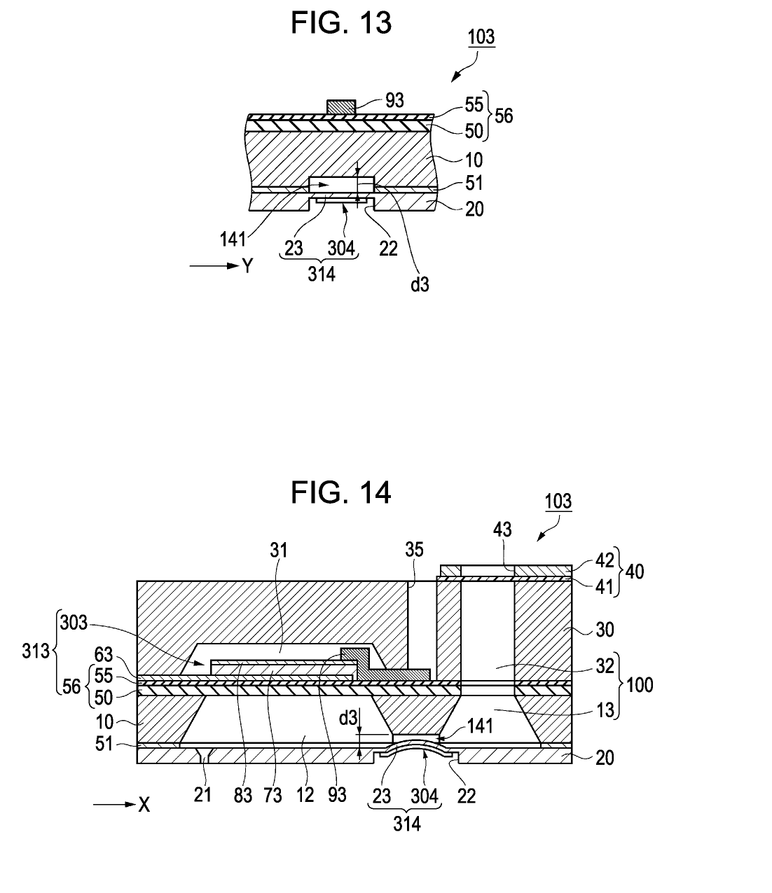

In FIG. 11 is shown an exploded perspective view schematically illustrating an ink jet type recording head 103 according to the third embodiment, in FIG. 12A, is shown a plan view schematically and partially illustrating an ink jet type recording head 103, and FIG. 12B, is shown a schematically cross-sectional view taken along line XIIB-XIIB of FIG. 12A. In FIG. 13 is shown a schematically cross-sectional view taken along line XIII-XIII of FIG. 12A. Similar constituent elements of the third embodiment as constituent elements of the first embodiment are given the same reference numerals.

In the view of the shape of the ink supplying passage 14 and that the flow rate control portion 140 is not used, the third embodiment is different from the first embodiment. In the view that a first piezoelectric element 303 and a first actuator apparatus 313 are provided instead of the piezoelectric element 300 and the actuator apparatus 310, and the second piezoelectric element 304 and the second actuator apparatus 314 is provided on the nozzle plate 20, the third embodiment is also different from the first embodiment. Also the second piezoelectric element 304 is omitted and described but has a structure that it is interposed between the upper and lower portions of the piezoelectric body in the same manner as the first piezoelectric element.

In FIGS. 11, 12 and 13, the first actuator apparatus 313 is provided with the first piezoelectric element 303, and the vibrating plate 56 as the first vibrating plate which includes a portion in which the deformation is generated by the driving of the first piezoelectric element 303. The first piezoelectric element 303 is also provided with a lower electrode 63, a piezoelectric body 73 and an upper electrode 83.

On the upper electrode 83, a lead electrode 93 is also provided, and the lead electrode 93 is connected to an external drive circuit (not shown) through a through hole 35 formed in the protection substrate 30.

The pressure generating chamber 12 and the communication portion 13 is connected to each other through an ink supplying passage 141. The ink supplying passage 141 is formed in such a manner that the surface of the side of the nozzle plate 20 of the flow passage forming substrate 10 is worked with a groove shape of depth d3 and is covered by the nozzle plate 20. In this case, the distance between the nozzle plate 20 and the bottom surface of the groove that forms the ink supplying passage 141 is set as d3.

A portion of the nozzle plate 20 that configures the ink supplying passage 141 is made with the thin thickness in which a recess 22 is formed, and the portion of the thin thickness is made up the second vibration plate 23. The second piezoelectric element 304 is provided on the second vibrating plate 23, and the second actuator apparatus 314 is configured by the second vibrating plate 23 and the second piezoelectric element 304.

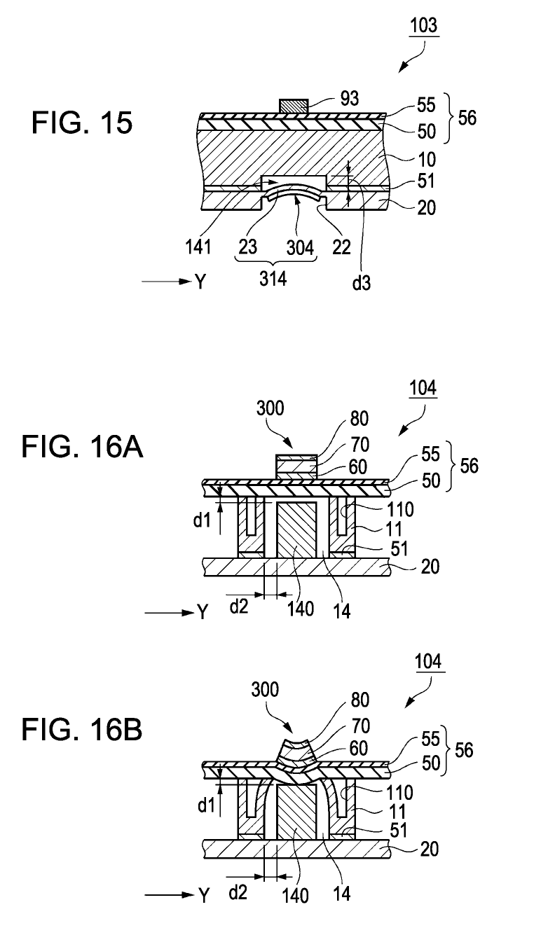

In FIG. 14 is shown a schematically cross-sectional view taken along line XIV-XIV of FIG. 12A in a case where the second piezoelectric element 304 is flexibly deformed in the direction of the ink supplying passage 141, and FIG. 15 is shown a schematically and partially cross-sectional view taken along line XV-XV of FIG. 12A. The state of the deforming flexibility is largely shown in the figures, as the first embodiment.

In FIGS. 14 and 15, if the second piezoelectric element 304 is flexibly deformed in the direction of the ink supplying passage 141, a gap between the nozzle plate 20 and the bottom surface of the groove that configures the ink supplying passage 141 narrows, and the nozzle plate 20 and the bottom surface of groove that configures the ink supplying passage 141 are contacted to each other, or the distance d3 shortens. In FIGS. 14 and 15, is shown the case that the distance d3 shortens.

It is possible to use the driving waveform of the first piezoelectric element 303 and the first actuator apparatus 313, and the driving waveform of the second piezoelectric element 304 and the second actuator apparatus 314, as described in the second embodiment.

By the above described third embodiment, the following effects are obtained in addition to the effects of the second embodiment.

(7) Since the second vibrating plate 23 which corresponds to the second piezoelectric element 304 and is different from the vibration plate 56 is provided on the nozzle plate 20, in addition to the vibrating plate 56 which corresponds to the first piezoelectric element 303 and configures a portion of the pressure generating chamber 12, the second vibrating plate 23 according to vibrating performance of the second piezoelectric element 304 which changes the flow passage cross-sectional area of the ink supplying passage 141 can be used. Therefore, when the ink that is filled in the pressure generating chamber 12 is ejected from the nozzle opening 21 that communicates with the pressure generating chamber 12, it is possible that the quantity of the ink which returns into the reservoir 100 through the ink supplying passage 141 is further decreased, the ejection quantity of the ink is further ensured, and the ink jet type recording head 103 in which the decrease of the ejection performance be further suppressed, is obtained.

### Modified Example

The modified example is configured as the first embodiment, except that a slit 110 is formed in the partition wall 11 corresponding to the ink supplying passage 14.

In FIG. 16A is shown a schematic partial and cross-sectional view taken along line XVIA-XVIA of FIG. 3A in which the ink jet type recording head 104 is shown as a modified example and in FIG. 16B is shown a partially and schematically cross-sectional view taken along line XVIB-XVIB of FIG. 3A in a case where the piezoelectric body 70 and the piezoelectric element 300 are flexibly deformed in the directions of each pressure generating chamber 12 as a modified example. Similar elements of the modified example as elements of the first embodiment are given the same reference numerals. Also the state of the deforming flexibility is largely shown in the figures as the first embodiment.

In FIGS. 16A and 16B, the slit 110 is formed on the partition walls 11 of opposite sides of the flow rate control portion 140. The slits 110 are formed on the sides in which the elastic film 50 of the partition walls 11 is contacted.

In FIG. 16B, if the piezoelectric body 70 and the piezoelectric element 300 are flexibly deformed in the direction of each pressure generating chamber 12, the gap between the flow rate control portion 140 and the elastic film 50 that forms the ink supplying passage 14 narrows, and the flow rate control portion 140 and the elastic film 50 are contacted to each other or the distance d1 shortens. In the figures, a case where the flow rate control portion 140 and the elastic film 50 are contacted to each other is shown.

In addition to this, in the modified example, the partition walls 11 that are divided by the slit 110 are deformed by the flexibility deformation of the piezoelectric body 70 and the piezoelectric element 300, and also the distance d2 between the flow rate control portion 140 and the partition wall 11 partially shortens.

By the above described modified example, the following effects are obtained in addition to the effects of the first embodiment. (8) Since at the same time as the distance d1 shortens by flexibility deformation of the piezoelectric body 70 and the piezoelectric element 300, the distance d2 between the flow rate control portion 140 and the partition wall 11 partially shortens, and the changing width of the flow passage cross-sectional area of the ink supplying passage 14 is increased. Therefore, when the ink that is filled within the pressure generating chamber 12 is ejected from the nozzle opening 21 that communicates with the pressure generating chamber 12, it is possible that the quantity of the ink which returns into the reservoir 100 through the ink supplying passage 14 is further decreased, the ejection quantity of the ink is further ensured, and the ink jet type recording head 104 in which the decrease of ejection performance is further suppressed, is obtained.

In addition to the above described embodiments and the modified example, it is possible that various modifications are made. For example, in the third embodiment, the shape of the ink supplying passage may be changed into the shape of the ink supplying passage 14 which is shown as the first embodiment, by using the flow rate control portion 140. In this case, the second piezoelectric element 304 and the second actuator apparatus 314 are provided in a position in which the flow rate control portion 140 of the nozzle plate 20 is formed, through the second vibrating plate 23.

In the above described embodiments and the modified example, although an ink jet type recording head is described as an example of the liquid ejecting head, it is intended for all of liquid ejecting head in a broad sense, and the invention may also be applied to a liquid ejecting head which ejects liquids other than the ink. For example, various recording heads which are used in an image recording apparatus in a printer or the like, a color material ejecting head which is used in the manufacture of a color filter in a liquid crystal display or the like, an electrode material ejecting head which is used in the electrode formation of an organic EL display, FED (field emission display) or the like, bio-organic materials ejecting head which is used in bio chip manufacture, or the like, are listed.

What is claimed is:

1. A liquid ejecting head comprising:
a pressure generating chamber that communicates with a nozzle opening for ejecting liquid;
a liquid supplying passage that communicates with the pressure generating chamber and a reservoir in which the liquid is stored; and
a piezoelectric element that changes the volume of the pressure generating chamber and a flow passage cross-sectional area of the liquid supplying passage by a vibrating plate.

2. The liquid ejecting head according to claim 1, wherein the pressure generating chamber and the liquid supplying passage include a nozzle plate which is provided at least on a passage forming substrate and the nozzle opening.

3. The liquid ejecting head according to claim 2, wherein the nozzle plate includes a projection portion which determines the cross-sectional area of the liquid supplying passage.

4. The liquid ejecting head according to claim 2, wherein the vibrating plate and the piezoelectric element are integrated with each other over the pressure generating chamber and the liquid supplying passage.

5. The liquid ejecting head according to claim 2, wherein the piezoelectric element includes a first piezoelectric element which changes the volume of the pressure generating chamber and a second piezoelectric element which changes the flow passage cross-sectional area of the liquid supplying passage.

6. The liquid ejecting head according to claim 5,
wherein the vibrating plate includes a first vibrating plate and a second vibrating plate,
the first vibrating plate defines a portion of the pressure generating chamber and the first piezoelectric element is provided on the first vibrating plate, and
the second vibrating plate defines a portion of the nozzle plate and the second piezoelectric element is provided on a side which is opposite to the passage substrate of surfaces of the second vibrating plate.

7. A liquid ejecting apparatus comprising:
a liquid ejecting head that includes:
a pressure generating chamber that communicates with a nozzle opening for ejecting liquid;
a liquid supplying passage that communicates with the pressure generating chamber and a reservoir in which the liquid is stored; and
a piezoelectric element that changes the volume of the pressure generating chamber and a flow passage cross-sectional area of the liquid supplying passage by a vibrating plate.

8. The liquid ejecting apparatus according to claim 7, wherein the pressure generating chamber and the liquid supplying passage include a nozzle plate which is provided at least on a passage forming substrate and the nozzle opening.

9. The liquid ejecting apparatus according to claim 8, wherein the nozzle plate includes a projection portion which determines the cross-sectional area of the liquid supplying passage.

10. The liquid ejecting apparatus according to claim 8, wherein the vibrating plate and the piezoelectric element are integrated with each other over the pressure generating chamber and the liquid supplying passage.

11. The liquid ejecting apparatus according to claim 8, wherein the piezoelectric element includes a first piezoelectric element which changes the volume of the pressure generating chamber and a second piezoelectric element which changes the flow passage cross-sectional area of the liquid supplying passage.

12. The liquid ejecting apparatus according to claim 11,
wherein the vibrating plate includes a first vibrating plate and a second vibrating plate,
the first vibrating plate defines a portion of the pressure generating chamber and the first piezoelectric element is provided on the first vibrating plate, and
the second vibrating plate defines a portion of the nozzle plate and the second piezoelectric element is provided on a side which is opposite to the passage substrate of surfaces of the second vibrating plate.
